(19) United States
(12) Patent Application Publication
(10) Pub. No.: US 2018/0346382 A1
(43) Pub. Date: Dec. 6, 2018

(54) METHOD OF MANUFACTURE AND USE OF LOAD BEARING INTERLOCKING STRUCTURAL BLOCKS AND MODULAR BUILDING SYSTEM

(71) Applicant: JUST BIOFIBER CORP., Calgary (CA)

(72) Inventor: WILLIAM RADFORD, Calgary (CA)

(21) Appl. No.: 15/970,669

(22) Filed: May 3, 2018

Related U.S. Application Data
(63) Continuation of application No. 14/815,854, filed on Jul. 31, 2015, now abandoned.
(60) Provisional application No. 62/032,192, filed on Aug. 1, 2014.
(60) Provisional application No. 62/100,790, filed on Jan. 7, 2015.

(51) Int. Cl. C04B 28/12; E04C 5/00; B28B 1/14; B28B 1/52; B28B 1/00; E04C 3/29; E04C 3/28; E04C 3/02; E04C 1/40; E04C 1/39; E04B 5/00; E04B 2/08; E04B 1/12; C04B 41/50; C04B 28/10; C04B 20/00; E04B 2/02

(52) U.S. Cl. CPC C04B 28/12; E04C 2003/023; B28B 1/14; B28B 1/523; B28B 1/002; E04C 3/29; E04C 3/28; E04C 3/02; E04C 1/40; E04C 1/397; E04C 1/39; E04C 1/24; E04B 2/08; E04B 1/12; C04B 41/5084; C04B 28/10; C04B 20/0068; B28B 1/525; E04B 2002/0245; E04B 2002/0254; E04C 5/00

(57) ABSTRACT

Method of making construction materials intended for use as structural elements, such as structural blocks, used in the construction of buildings and civil engineering structures. In one aspect, the blocks may comprise a body shape configured so as to allow it to interlock with other blocks in the construction of a structure. Methods for manufacturing the blocks and structures comprising such materials and methods for building such structures are also disclosed.

### FIELD OF THE INVENTION

The invention disclosed herein relates to particular construction materials, as well as processes for preparation and uses of such materials. Such materials may be intended for use as structural elements, such as structural blocks, used in the construction of buildings and civil engineering structures.

### BACKGROUND OF THE INVENTION

The production of blocks for masonry using vegetal additions incorporated in a lime-based binder matrix (for example hemp used to produce Chanvribloc™ blocks) is a known process in the art.

The prior art also discloses blocks used in the construction of structures, such as houses and commercial buildings, which may have properties that are either insulating or load bearing.

WO 2014072533 discloses an insulating construction material with an alleged low thermal conductivity comprising vegetal additions, as well as to a process for preparation and to uses of such a material.

It would be advantageous for there to be a structural block that had a composition and configuration that integrated both load bearing capabilities with insulating properties.

It would also be advantageous for there to be further means for providing additional reinforcement and tension bearing capabilities to a structural block.

### SUMMARY OF THE INVENTION

The invention disclosed herein relates to the manufacture of particular construction materials, as well as processes for preparation and uses of such materials and the materials themselves. Such materials may be intended for use as structural elements, such as structural blocks, used in the construction of buildings and civil engineering structures. When the materials are used in the production of structural blocks, such blocks may integrate load bearing capabilities together with insulating properties.

In accordance with an aspect of the present invention, structural blocks are provided that may be configured to interlock with complimentary blocks in the construction of a structure.

In accordance with another aspect of the invention, an interlocking structural block is provided comprising a plurality of members embedded within the block, one end of the member extending through one surface of the structural block and an opposite end of the member terminating partway within the structural block, a plurality of apertures extend within the structural block from a second surface of the structural block, the apertures adapted for engaging with an extending end of an adjacent structural block.

In accordance with a further aspect of the present invention, an interlocking structural block is provided comprising a block body having opposed top and bottom surfaces, opposed side surfaces and opposed end surfaces, a plurality of members embedded within the block, one end of the member extending through the top surface of the structural block and an opposite end of the member terminating partway within the structural block, wherein the embedded members comprise material which is substantially non-compressible along its length and contribute to the load bearing attributes of the structural block under compression, a plurality of apertures extending within the structural block from the bottom surface of the structural block to the terminating end of an embedded member of the structural block, the apertures adapted for engaging with an extending end of an adjacent structural block, at least one perforated tube embedded within the structural block, and at least one conduit for accommodating electrical wiring, piping or utilities.

In accordance with another aspect of the invention a system of auto-aligning interlocking structural blocks is provided, comprising a plurality of structural blocks, each block having opposed top and bottom surfaces, opposed side surfaces and opposed end surfaces, a plurality of members embedded within the block, one end of each member extending through one surface of the structural block with an opposite end of the member terminating partway within the structural block, a plurality of apertures extending through the structural block from an opposed surface, wherein the embedded member extending end of a first structural block engages with the aperture of a second block, such that the embedded member terminating end of the second block is in direct contact with the embedded member extending end of the first block.

The fabrication of the blocks of the present invention may be attained by means using a mold process.

During manufacture, the embedded members or struts may be cut to the desired length, such as, for example, 8 inches in length. A hole may be drilled through the lengths of the bodies of those members that will serve as conduits for the tensioning means.

A desired number of struts and perforated tubes are placed into a mold at the desired positions, in a jig.

A mixture comprising the components of the block's composition may be combined and mixed. The mixture may then be, for example, poured, sprayed or injected into the mold.

The composition may be compressed and/or heated and allowed to set. During the curing process, carbon dioxide may be injected or passed by (or through conduits within) the curing block, which decreases the cure time. Depending on the lime composition used, the blocks may also be cured in an autoclave to control the temperature, humidity and carbon dioxide environment.

A lime coating may be applied to the inner and outer face of the blocks at time of manufacture which may increase the block strength and reduce construction finishing time.

The blocks of the present invention may be pre-manufactured and then cut as desired on site.

A further aspect is the use of the interlocking structural blocks of the present invention in the manufacture of a structure.

Further aspects, features and advantages of the present invention will be apparent from the following descriptions and claims.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and accompanying drawings in which:

FIG. 1 is a front perspective view of a structural block in accordance with the present invention;

FIG. 2 is a bottom perspective view of the structural block of FIG. 1;

FIG. 3 is a bottom view of the structural block of FIGS. 1-2;

FIG. 4 is a top view of a structural block in accordance with the present invention;

FIG. 5 is a front perspective view of a structural block comprising conduits therethrough, in accordance with a preferred embodiment of the present invention;

FIG. 6 is a bottom perspective view of the structural block of FIG. 5;

FIG. 7 is a bottom view of the structural block of FIGS. 5-6;

FIG. 8 is a top view of a structural block comprising perforated struts in accordance with a preferred embodiment of the present invention;

FIG. 9 is a front view of the structural block of FIG. 8;

FIG. 10 is a side view of the structural block of FIGS. 8-9;

FIG. 11 is a perspective view of a structural block adapted to accommodate a tensioning system therethrough;

FIGS. 12A, 12B and 12C show various views and types of structural blocks adapted to accommodate a tensioning system;

FIG. 13 is a perspective view of a preferred embodiment of a tensioning system comprising a hex swage tensioner;

FIGS. 14A, 14B, 14C and 14D show various views and types of structural blocks adjoined together through a tensioning system;

FIG. 15 is a top view of a structural block adapted to accommodate a compression strut;

FIG. 16 is a front view of the structural block of FIG. 15;

FIG. 17 is a side view of the structural block of FIGS. 15-16:

FIG. 18 is a front view of another structural block adapted to accommodate a compression strut;

FIG. 19 is a side view of the structural block of FIG. 18;

FIG. 20 is a back view of the structural block of FIGS. 18-19; and

### DESCRIPTION OF THE PREFERRED EMBODIMENT

The present invention relates to particular construction materials, as well as processes for preparation and uses of such materials. When describing the present invention, any term or expression not expressly defined herein shall have its commonly accepted definition understood by those skilled in the art. To the extent that the following description is of a specific embodiment or a particular use of the invention, it is intended to be illustrative only, and not limiting of the invention, which should be given the broadest interpretation consistent with the description as a whole.

The construction materials of the present invention are intended for use in structural elements for building structures and civil engineering structures.

In one embodiment, the materials are used in the production of structural blocks. In one aspect, the blocks of the present invention may be designed so as to integrate compression and torsional load bearing capabilities with insulation properties.

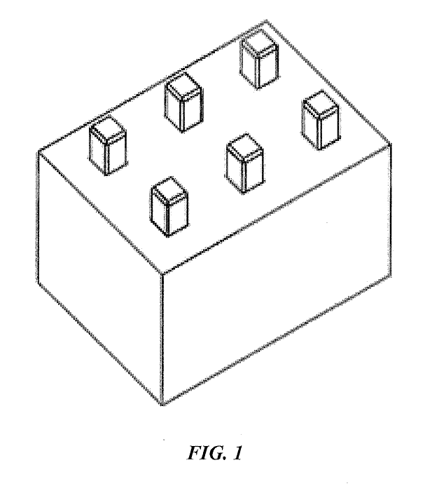

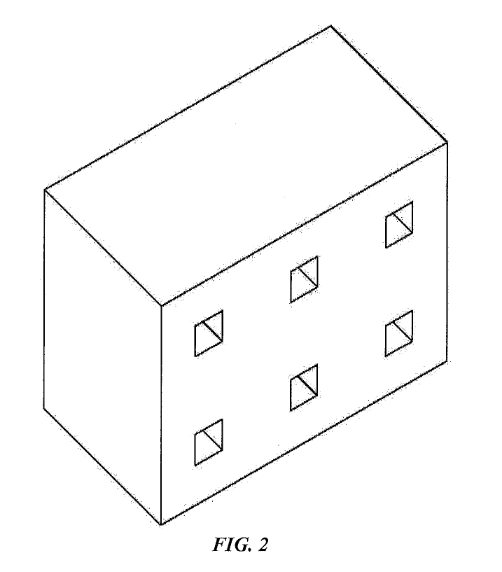

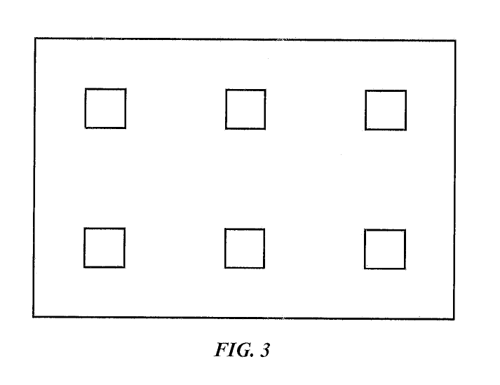

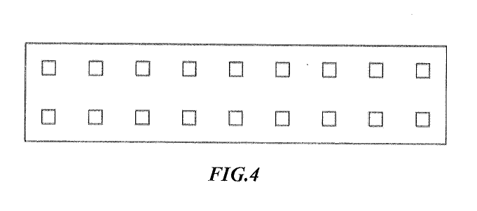

FIGS. 1-4 illustrate structural blocks in accordance with preferred embodiments of the present invention. As illustrated in FIGS. 1-4, each block of the present invention may comprise a body shape configured so as to allow it to interlock with other blocks when constructing a structure, such as a wall or house. Such design can provide further strength to the overall structure.

In one embodiment, each block can accommodate one or more embedded member. The member, which may also be termed a strut in the art, may be embedded within the block or inserted during building construction and may contribute to the load bearing properties of the block, particularly compression loads. One end of the embedded member may protrude out a given distance from one side of the block, while the opposite end of the embedded member may terminate partway within the block on an opposite side.

In another embodiment, the embedded member may be flush with the surface of the block and a positioning device may also be used to align and join the members together. For example, a tube with directional clips may be used between blocks to grip the abutting member ends in adjacent blocks.

A recess or opening can be formed within the block and can extend from the terminating end of the embedded member within the block through to the surface of a side of the block, opposite to the side through which the embedded member protrudes.

In one embodiment, the extended end of the embedded member may protrude from the block by a distance that is approximately equivalent to the depth of the recess within the block. By way of example, a block with a height of 8 inches may accommodate an embedded member that is 8 inches in length. The protruding end of the member may extend 2 inches out from the surface of one side of the block, with the remaining 6 inches embedded within the block. A recess formed within the block at the member's opposite end may be 2 inches in depth. The recess may extend immediately from the terminating end of the embedded member housed in the block, to the surface of the opposite side of the block.

A recess can be of a size, shape and may be spaced apart from one another so as to align with and accommodate the protruding end of an embedded member of another block. Such an arrangement may be similar to an interlocking “pin and socket” arrangement and can function as a locating means for the purpose of accurately positioning a block with respect to an additional block(s) while also contributing to the load bearing attributes of the block under compression.

When the protruding end of an embedded member of one block is positioned into the corresponding recess of a second block, the protruding end of the embedded member may be in direct contact with the terminating end of the embedded member of the second block. As a result, the blocks can be said to auto align, and the embedded members can be said to form a stacked structure forming a load bearing structural member.

For ease of assembly, a recess within the block may have a width that is some measurement greater than the width of the embedded member. In one embodiment, the width of the recess may be ¼ inch wider than the width of the member, for example, ⅛ inches on either side of the recess (on each of the four sides when the block and recess are square), to accommodate ease of insertion of the protruding member of an adjacent block.

Any suitable binding agent, such as lime mortar for example, may be used to bind the protruding end of an embedded member of one block into the corresponding recess of a second block. Such a bond, when formed, may be stronger than the block itself.

When the embedded member and corresponding recess are interlocked, a molecular bond may be formed that can contribute to the load bearing or other structural properties of the block. In some instances, the load bearing capabilities of the block of the present invention may be several times greater than that of a hollow concrete block, and more similar to or exceeding that of a conventional stud-framed wall structure.

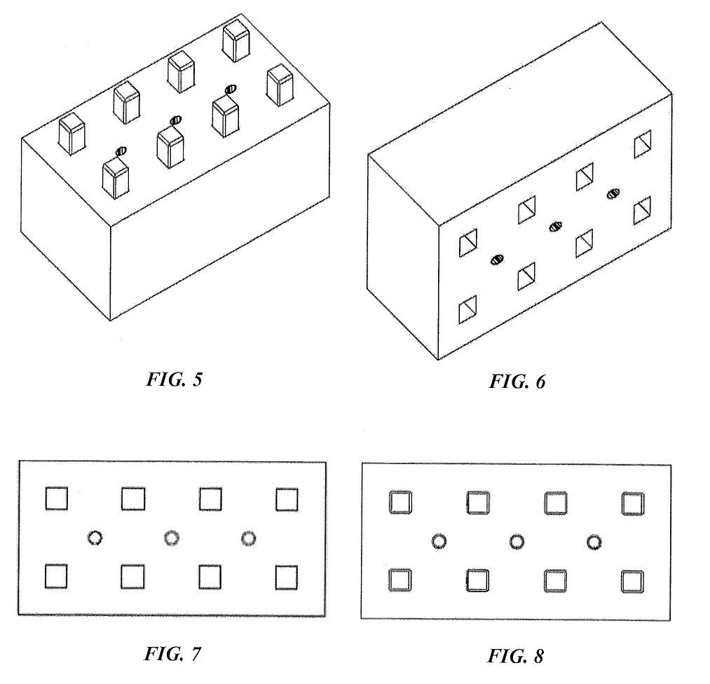

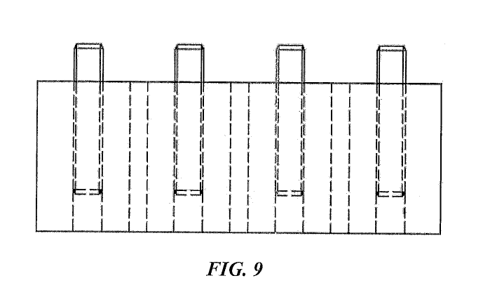

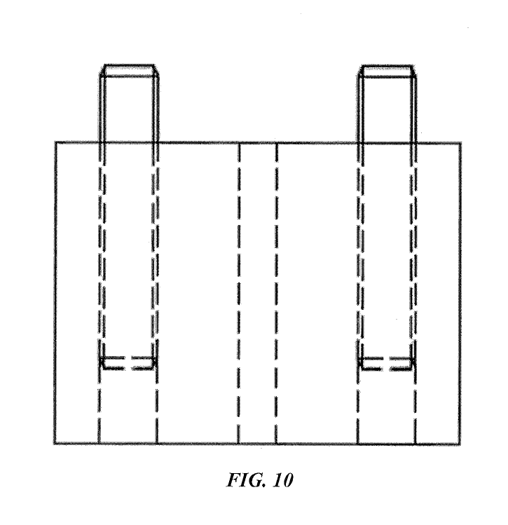

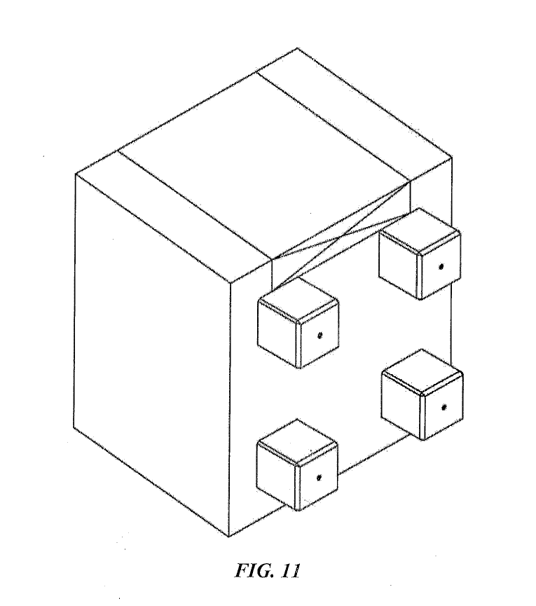

In another embodiment, holes may be created on the block that may be positioned an equal distance between the embedded members. As illustrated in FIGS. 5-7, the holes may be used to create a conduit to accommodate electrical wiring or other utilities inside, for example, a structure's wall. The holes may also be beneficial to the curing process, by exposing the block's interior, for example, to injected carbon dioxide. In an alternate embodiment, some strut members may be hollow and slotted. As illustrated in FIGS. 8-10, in another embodiment, additional perforated tubes or struts may be incorporated in the blocks therethrough.

The composition of the member or strut itself may comprise any rigid material or mixtures thereof, with any preferences to materials used directed to cost considerations and load bearing capabilities of the material. In a preferred embodiment, the embedded member may comprise any wooden material, such as fir, spruce, pine, cedar, etc. The element may also comprise composites of organic or inorganic fibers, such as hemp or carbon fiber, etc. In yet a further embodiment, the embedded member may comprise a blend of bio fibers and polymers, such as polyethylene, polypropylene or polyester. Some compatible metals may also be used. A member or strut may also be hollow, such as a hollow square or cylindrical tube. Other materials may include metals, carbon fibre or composites, 3D printed or extruded plastics or any suitable structural members.

### Tensioning System

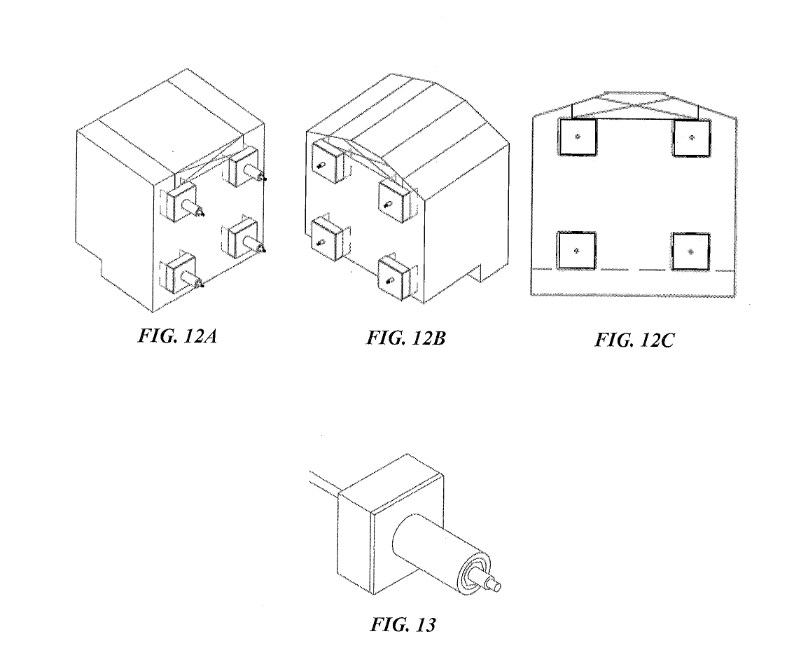

In one embodiment, the block of the present invention may be adapted so as to be tension bearing as well. As illustrated in FIGS. 11-12, a block may be further adapted so as to accommodate a tensioning system that can provide tension. In such an embodiment, the embedded member of the block can accommodate a tensioning means though the length of the member, such tensioning means entering through the one end of the member and exiting through the other end of the member.

In one embodiment, the tensioning means may be a cable, such as, for example, a tensioned non-stretch stainless steel cable. In an alternate embodiment, the system may comprise a rod.

As illustrated in FIG. 13, when the tensioning system includes a cable, the tensioning end assembly can comprise a hex swage tensioner, in addition to the cable.

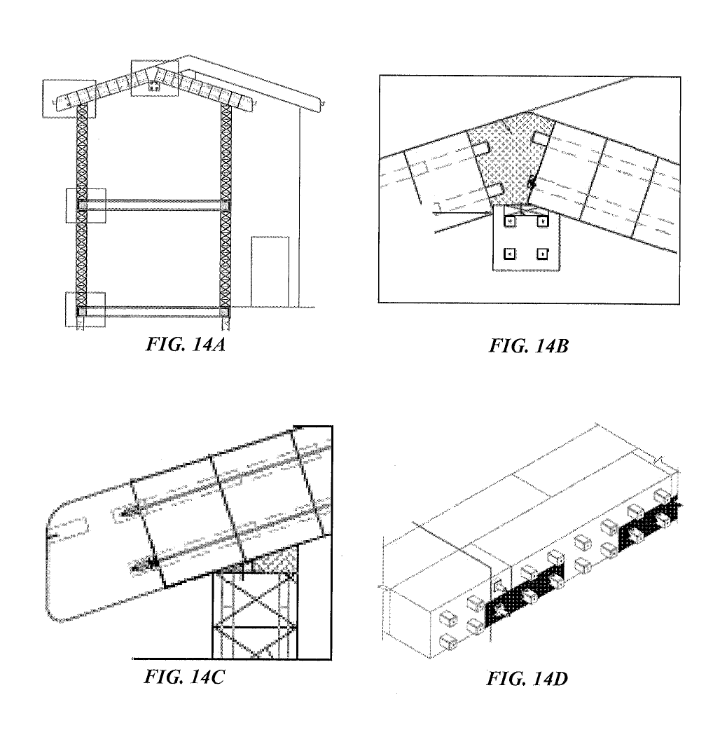

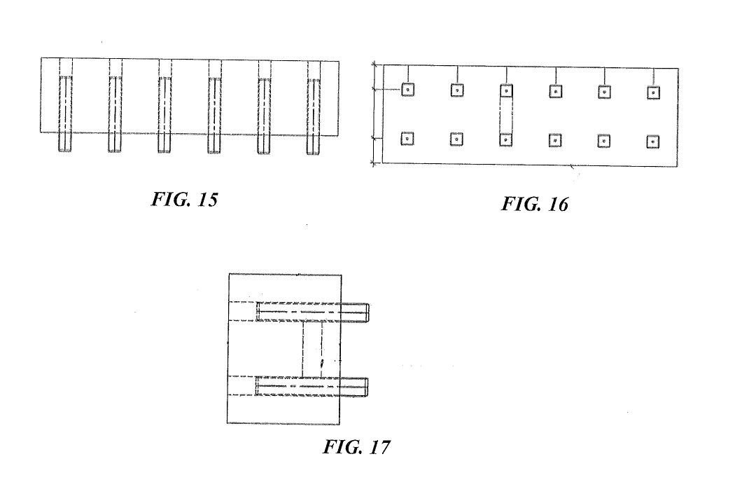

As illustrated in FIG. 14, when assembled, the embedded members of each block can be aligned with the corresponding members of other blocks, to allow the passage of the tensioning means through multiple embedded elements and blocks.

Such a configuration provides a further fastening means for a structure comprising the blocks of the present invention. In particular, such a configuration may be tension bearing, in that the blocks may be adjoined together through tension suitable for non-vertical structural elements such as floors, walls, pitched or flat roof surfaces, etc.

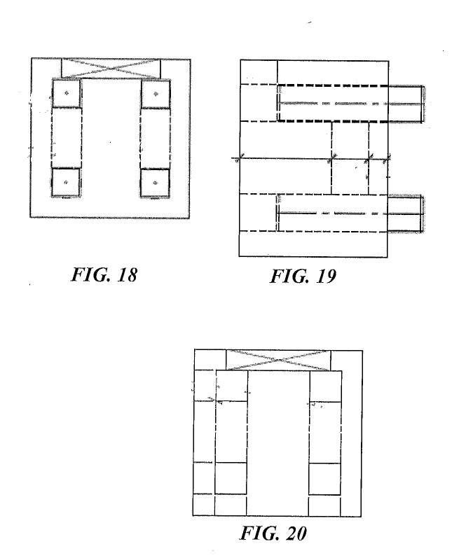

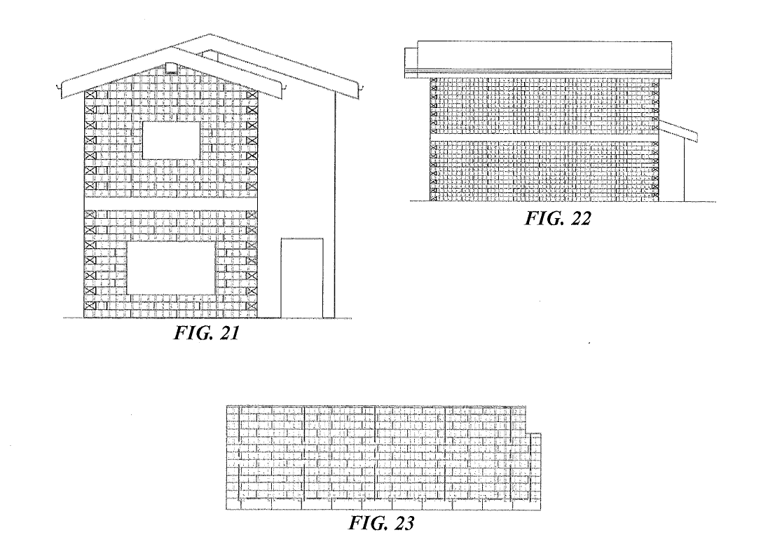

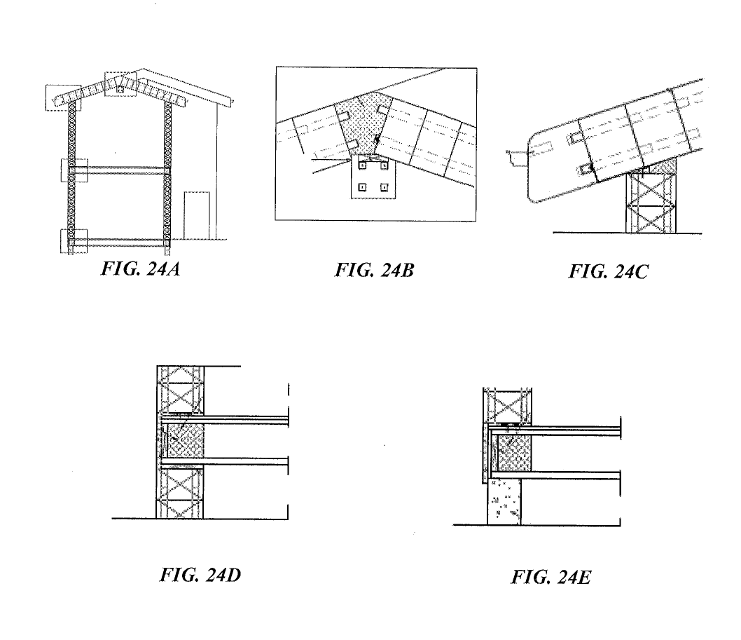

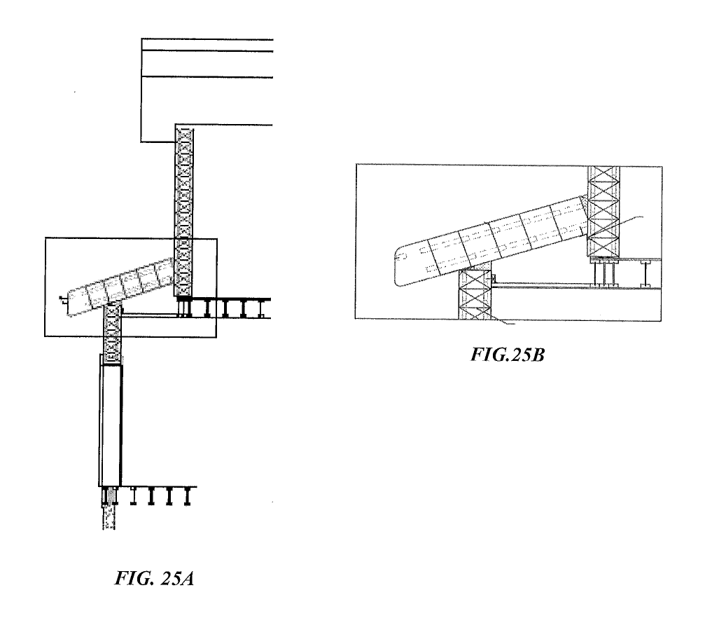

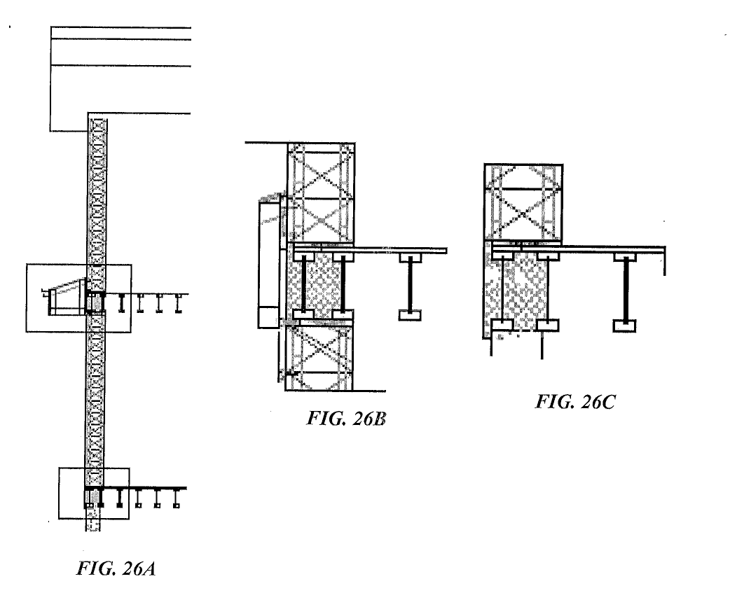

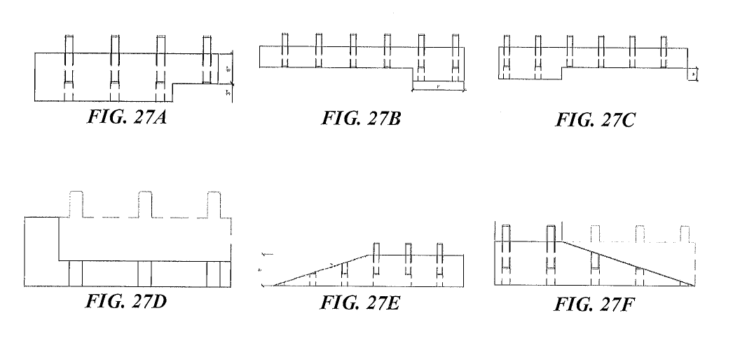

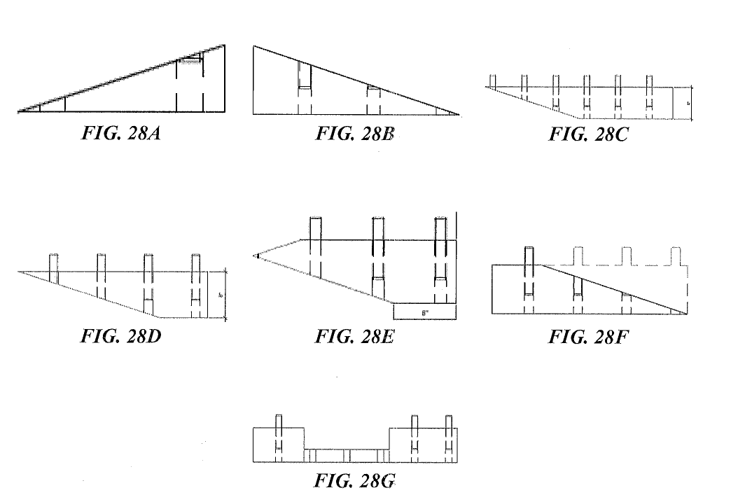

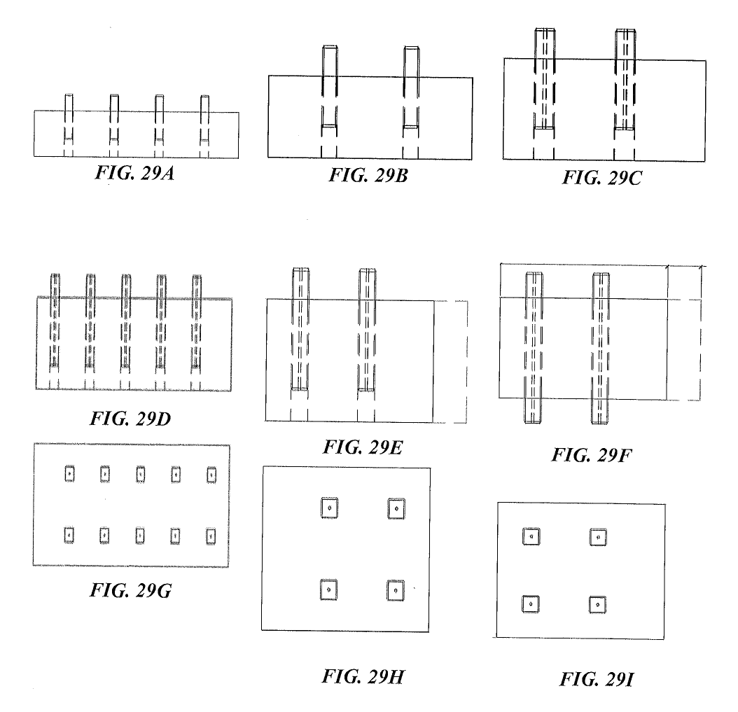

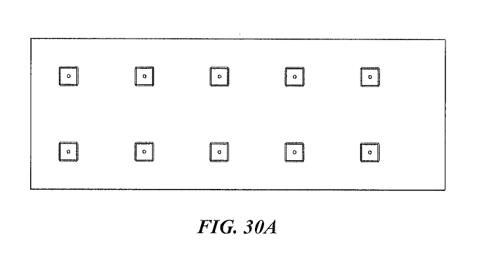

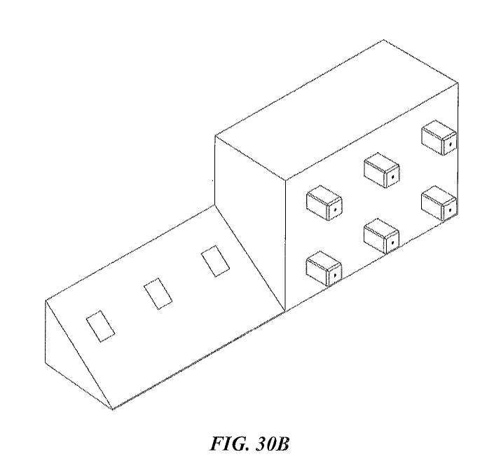

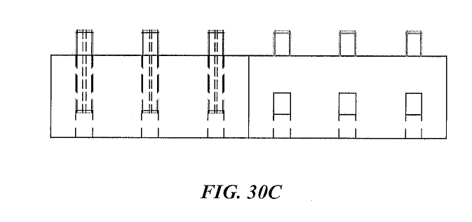

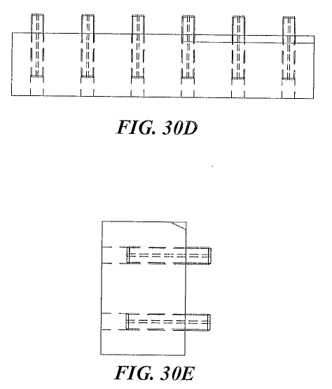

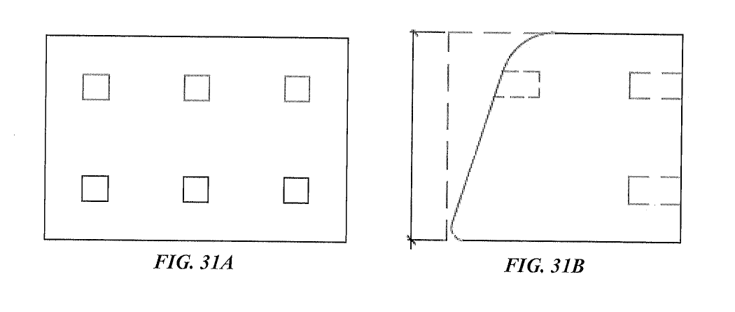

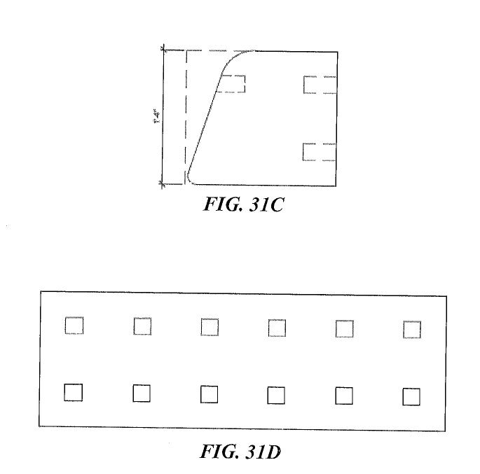

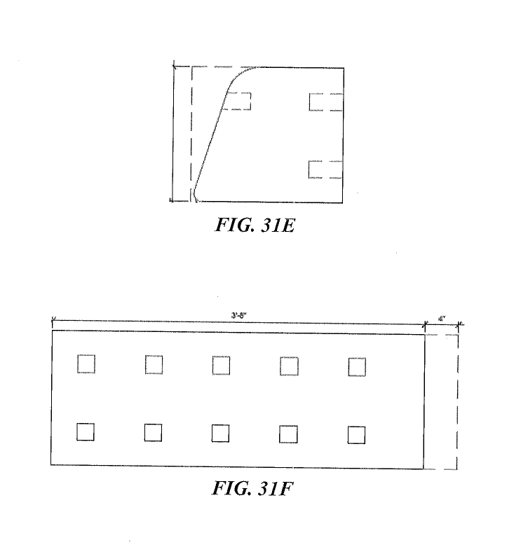

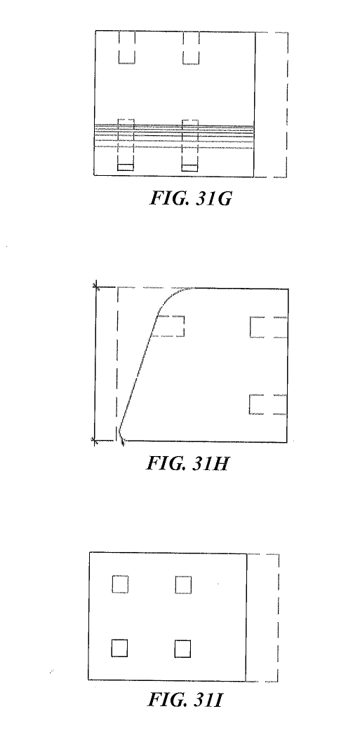

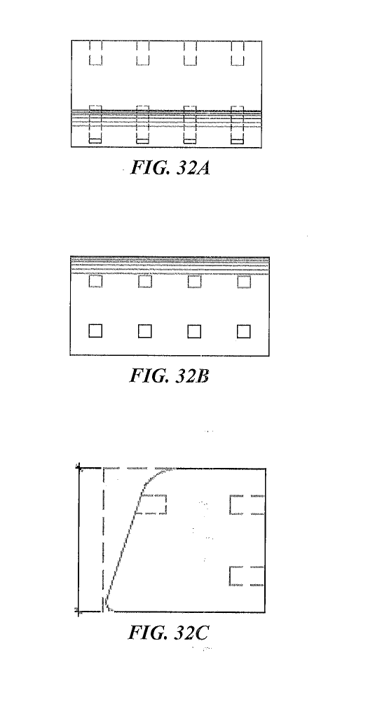

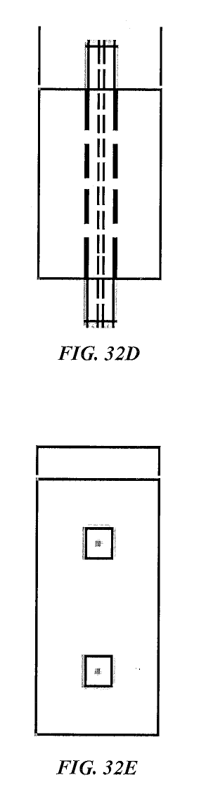

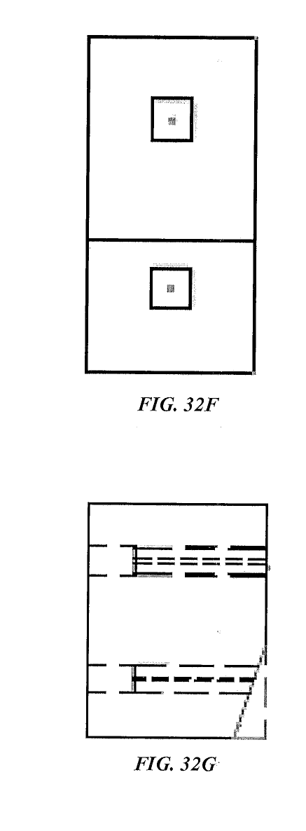

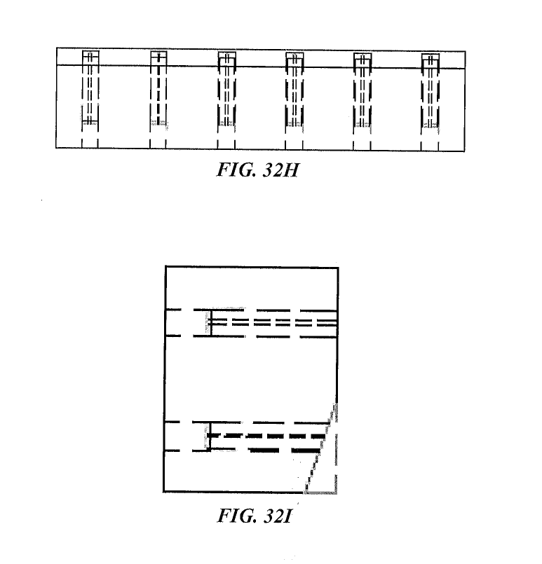

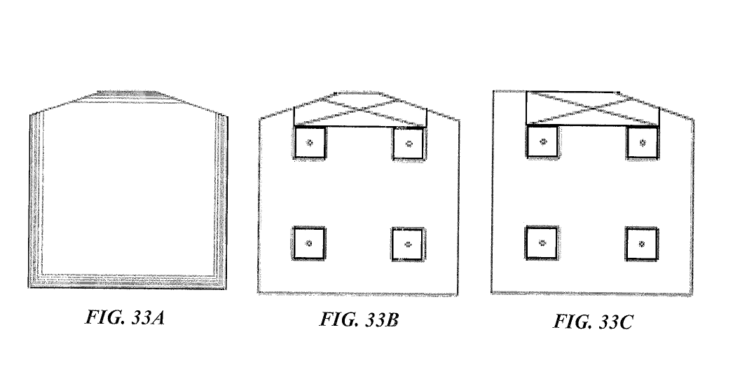

In another embodiment, an additional member, which may be termed a compression strut or web element (or many), can be used for the purpose of increasing the strength of the structural element formed by assembled blocks. As illustrated in FIGS. 15-20, a compression strut may, for example, be placed approximately perpendicular between and in contact with a pair of existing members or struts integrated into the body of the block each of which accommodates a cable as tensioning means. The application of one or more compression struts in this embodiment may assist in keeping the embedded member pair properly spaced, without needing structure inherent in the block material, keeping the adjacent pairs of struts essentially equidistant throughout their length, with or without tensioning.

Other elements such as strut caps and/or mounting plates may be used in accordance with the present invention. By way of example, a strut cap may be set into a block over the protruding end of an embedded member, with the extending end extruding from the cap.

In practice, the tensioning means may be tensioned post construction, after the blocks have been aligned.

When the tensioning means comprises a cable, the tensioning procedure with regard to a roof, for example, may include the following steps:
(i) Beams may be assembled using the tension blocks on a flat horizontal surface and pre tensioned by use of cables and lifted into position. Alternatively scaffolding would be required to assemble in place and post tension the blocks using cables.
(ii) Once the roof is constructed (minus the end caps) the non-swaged end of the cable is fed through the embedded member, starting at the peak of the roof.
(iii) The cable is pulled taught.
(iv) The second end of the cable is swaged as close to the hex tensioner as possible.
(v) The hex tensioner is tightened as much as needed.

In one embodiment, the frequency of tensioning means may need be applied only as required, for example, every meter of the assembled structure, to form a floor, roof, or other non-vertical structure, or can be a wall.

### Bio-Fiber Structural Block

In a preferred embodiment, the body of the block of the present invention can comprise a primarily fibrous and lime composition. Specifically, the composition for each block may comprise the following components:
(i) hemp hurd, and fibers
(ii) flax fiber
(iii) hydraulic lime
(iv) hydrated lime

Certain benefits may be realized through the practice of a block comprising the preferred composition of the present invention. Compositions comprising hemp hurd, flax, hydraulic lime and hydrated lime may be environmentally sustainable, recyclable and may sequester carbon dioxide from the atmosphere, while providing exceptional insulating qualities.

While a concrete block may need to be restricted in size, for example 16 inches, due to weight for handling, a block of the present invention may have a length of 48 inches or more and may maintain ease of handling because of its lower density, for example, 300 kg/cubic meter.

The lime component may primarily act as a binding agent, holding the other components together. However, any suitable binding agent may be substituted in instances, for example, when a stronger bonding agent may be required. Suitable alternative binding agents can include polymer based agents, for example silica sand, pozzolans, polyester resins, or Portland or similar cement or plaster. Such alternative agents may also be used in combination with the lime component of the preferred embodiment.

The hemp hurd and fiber component can provide insulating properties, bulk, support and strength to the block and structural members in the block. However, any alternate material or combination of materials that can provide similar desirable properties may be used in the alternative. Some organic alternatives include fibrous materials, such as corn stocks, cereal grain, straw, etc. Hemp hurd is a preferred material, primarily due to its insulating qualities in relation to the other fibers.

Alternatively, non-organic materials such as Styrofoam/polystyrene or non-recyclable plastics may be used. Such materials may also be used in a shredded form. Structural fibers (oriented cellulose strands, plastics, metal or carbon filaments) may also be incorporated or substituted. The application of these non-organic alternatives may provide an additional advantage, in that such non-recyclable materials may be sequestered from the environment, or may add different qualities to the blocks (strength, conductivity, electrical or RF shielding, noise abatement, etc.).

### Recyclable and Sustainable

The composition of a preferred embodiment comprises hemp hurd, flax, hydraulic lime and hydrated lime. The primarily fibrous-lime combination is organic and composed of bio-recyclable material. When the useful life of a structure that uses such blocks comes to an end, its components may be recycled. For example, the entire block may be ground up and remixed for further subsequent applications.

The components of the composition are also sustainable. For example, hemp hurd, in addition to its favorable properties, is readily available in supply and grows very quickly with little water and fertilizer.

Other favorable properties may be realized by the fibrous-lime composition of the preferred embodiment. In particular, such a combination allows the building to “breathe”. Air and humidity can pass both in and out of the blocks at a very slow rate. No vapor barrier may be required to be used.

The composition may also be resistant to mold, termites and other insect pests.

A structure using the block composition of the preferred embodiment may allow for fire resistance, due to the properties of the hemp hurd and lime mixture, or other compositions.

In another embodiment, the blocks of the present invention may be further coated with a lime finish. A block of the present invention may be coated with several, for example five or more, coats of lime.

A structure using the blocks of the present invention can be bonded to become monolithic. Such properties can be especially beneficial particularly in areas prone to earthquakes, hurricanes or tornados.

Water proofing or moisture resistant properties may also be realized, particularly by use of the lime component. The lime component can also allow a block of the preferred embodiment to “heal” itself. For example, a crack in the lime coating can close over time when it is subjected to moisture.

### Carbon Dioxide Sequestration

The carbon dioxide sequestration properties of a block that comprises the preferred composition of the present invention allows for the removal and sequestration of the greenhouse gas carbon dioxide from the Earth's atmosphere.

The hemp hurd component of the composition can sequester carbon dioxide at a rate of over approximately 20 tonnes per hectare as the plants grow.

It is estimated that the hemp hurd-lime composition blocks of the preferred embodiment have the capability to capture/absorb over approximately 100 kilograms of carbon dioxide per cubic meter. The lime component can use carbon dioxide to cure and set the mixture. An average house comprising such blocks, for example, can capture approximately 13,000 kilograms of carbon dioxide during block production and can continue absorbing carbon dioxide for approximately 100 years.

### Methods of Manufacture

The fabrication of the blocks of the present invention may be attained by means using a mold process.

During manufacture, the embedded members or struts may be cut to the desired length, such as, for example, 8 inches in length. A hole may be drilled through the lengths of the bodies of those members that will serve as conduits for the tensioning means.

A desired number of struts and perforated tubes are placed into a mold at the desired positions, in a jig.

A mixture comprising the components of the block's composition may be combined and mixed. The mixture may then be, for example, poured, sprayed or injected into the mold.

The composition may be compressed and/or heated and allowed to set. During the curing process, carbon dioxide may be injected or passed by (or through conduits within) the curing block, which decreases the cure time. Depending on the lime composition used, the blocks may also be cured in an autoclave to control the temperature, humidity and carbon dioxide environment.

A lime coating may be applied to the inner and outer face of the blocks at time of manufacture which may increase the block strength and reduce construction finishing time.

The blocks of the present invention may be pre-manufactured and then cut as desired on site.

### Building Structure and Related Materials

In a preferred embodiment, such building materials may include blocks as disclosed in the present invention. Consequently, the blocks used in the structure of the present invention may be load bearing, tension bearing and insulating.

The blocks used may be of standard building construction dimensions. Height width and length may vary, depending upon the application, orientation and desired insulation requirements. For example, the blocks used for the walls of a structure may be a standard 11″ thick and 8″ high, while varying in length. Roof structure blocks may be 12″ high and 16″ wide.

The building materials may also be pre-manufactured prior to being transported to an intended building site for assembly.

A 1400 square foot house structure is provided by way of example below.

### Wall Blocks

The wall blocks can be of a standard height and width, and may vary in the length. The wall blocks may be a standard 11″ deep and 8″ high, and may vary in the length. The total count below includes blocks that may be cut on site.

4″: 8
8″: 12
12″-2 struts: 13
12″-4 struts: 29
16″: 7
20″: 13
24″: 63
32″: 97
36″: 43
48″: 644
Total wall block count: 929
48″ wall starter strips-(may be made of pressure treated plywood):65
Roof blocks
R=roof
Ed=edge (always 48″)
S=starter
E=end
P=peak
Total counts include blocks that may be cut on site.
R24′: 1
R32″: 2
R48″: 198
Red: 20
Re24: 2
Re32: 1
Re48: 19
Reed: 2
Rs24: 1
Rs48″: 23
Rsed: 2
Rp24″: 2
Rp48″: 21
Rped: 2
Total roof block count: 296
Beam blocks
Standard 16″: 36
16″ end block: 1
16″ end cap: 2
Standard 12″: 4
12″ end cap: 1
Total beam block count: 44

### Structural Ties

Structural ties may be breathable and in one embodiment, may be made from 16 gauge stainless steel mesh.

### Roof/Wall Structural Tie: 23

Peak tie: 30

Square mesh tie: 25

Structural bracket: 5

### Wood (Rough Cut Unless Noted Otherwise)

1½″×12″×12″ under 12″ beam: 1

1⅝″×12″×16″ under 16″ beam: 2

2′×6′ roof starter block support (1 each):

37′-8″ long

35′-8″ long

11′-8″ long

2′ long

2×6 window/door headers and footers (dressed):

6′-4″ long: 2 (master bedroom window)

9′ long: 2 (living room window)

5′ long: 1 (front door)

8′-4″ long: 1 (back door/window)

3′-8½″ long: 1 (back window footer)

6′ long: 4 (bedroom windows)

2×4 window/door trim (dressed)

6′-8″ long: 4 (doors)

3′-4″ long: 8 (windows—not living room)

4′-8″ long: 2 (living room windows)

### Fasteners

The fasteners used should be compatible with lime construction and can include stainless steel or ceramic coated fasteners.

### Finish of the Structure

In an embodiment of the present invention, lime mortar or another suitable mortar may be brushed on all block faces that are adjacent to another block face. As a result, this can create a structure that is monolithic and sealed.

The interior walls of the structure of the present invention may be a lime rendering, which may be colored or have breathable paint applied over it. In an alternative embodiment, there is no further application required to the interior walls. In another embodiment, the interior walls may also be covered in panels of sheetrock, wood veneer or brick, preferably with approximately a minimum 1″ air space constructed between the bricks and the interior paneling.

The exterior walls of the structure of the present invention may have a plain coat bio-fiber and lime finish applied. Such an application can add to monolithic quality and building strength with a more finished look and a non-fading or fading resistant color finish. In another embodiment, the exterior walls can have a mortar application, or “stucco look”. Such an application can also add to monolithic quality and building strength with a more finished look and a non-fading or fading resistant color finish. In a further embodiment, typical wall siding brick veneer and other non permeable materials may be used, and should maintain a minimum 1″ space from the block surface. In yet another embodiment, there is no further application required to the exterior walls, and the blocks may be formed with a decorative exterior surface on them. The blocks may have embossed or patterned surfaces for decorative or other purposes such as sound absorption, water-shedding, light reflectivity and so on.

Any roofing material known in the art may be used in conjunction with the roof of the present invention structure. If non-breathable material is used, there should be an approximately one inch minimum space between the non-breathing material and the roof block. In one embodiment, the roof may be coated, for example, with a 7 coat, 100 year lime finish. In an alternative embodiment, the roof may further comprise bio-fiber breathable “clay-like” tiles which may not require an air space.

### Preferred Proposed Block Benefits

A most preferred embodiment of the present invention would possess some or all of the following characteristics:
Strong load bearing capabilities
Excellent insulating properties R26 to R40 or λ=0.07 W/m·K with 100% thermal break
Excellent fire rating
Environmentally sustainable, Carbon zero or negative co2 building material classification
Good thermal inertia and thermal mass characteristics to regulate inside temperature
Excellent air and humidity permeability
Conforms to existing building standards and dimensions making it easy for contractors and architects to implement. Conventional fasteners such as stainless steel or Ceramic coated screws may be used
Lightweight for ease of handling and requires no skilled labour for construction assembly
Very rapid construction, Constructed walls are weatherproof and finishes may be applied immediately. Factory prepared face surfaces require minimal interior and exterior finishing
Standard sizes may permit robotic or machine-assisted assembly at site
Integrated conduit paths within blocks to accommodate electrical and utilities

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention.

What is claimed is:

1. A method for manufacturing an interlocking structural block comprising:
(a) positioning a plurality of members into a mold using a jig, such that one end of a member will extend from one surface of the structural block being formed, with an opposite end of the member terminating partway within the structural block and elevated from a floor of the mold, wherein the mold is adapted for forming a plurality of apertures extending within the structural block from an opposing surface of the structural block, the apertures adapted for engaging with an extending end of an adjacent structural block;
(b) mixing a primarily fibrous material with a primarily lime based material for forming a block composition;
(c) applying the block composition into the mold;
(d) curing the block composition in the mold, such that the block composition is allowed to form and harden around the plurality of members;
(e) injecting a quantity of carbon dioxide into the block composition; and
(f) resting the block composition in the mold for a predetermined period of time.

2. The method of claim 1, further comprising the step of compressing the block composition prior to the curing step.

3. The method of claim 1 further comprising the step of heating the block composition during the curing step.

4. The method of claim 3, wherein the block composition is cured in an autoclave, operational for controlling one or more of the temperature, humidity, or carbon dioxide environment.

5. The method of claim 1, further comprising the step of coating one or more surfaces of the structural block with a lime coating after the structural block has set.

6. The method of claim 1, wherein the members are constructed to have a square cross section and the mold is adapted for forming a plurality of apertures each having a square cross section.

7. The method of claim 1, wherein the members are constructed to have a round cross section and the mold is adapted for forming a plurality of apertures each having a round cross section.

8. The method of claim 1, further comprising a step of forming a hollow cavity in one or more of the members.

9. The method of claim 1, further comprising a step of forming one or more of the members with a slotted configuration.

10. The method of claim 1, further comprising a step of forming the members from a material which is substantially non-compressible along its length and contributes to the load bearing attributes of the structural block under compression.

11. The method of claim 1, further comprising a step of forming the members from wooden materials, organic fibers, inorganic fibers, composite materials, polymers, metallic materials, polymers, plastics, resins, or any combination thereof.

12. The method of claim 11, wherein the wooden material is fir, spruce, pine cedar, or any combination thereof.

13. The method of claim 1, wherein the primary fibrous material comprises organic materials.

14. The method of claim 13, wherein the primarily fibrous material comprises hemp hurd, flax, corn stock, cereal grain, straw, cellulose strands or any combination thereof.

15. The method of claim 1, wherein the primarily fibrous material comprises inorganic materials.

16. The method of claim 15, wherein the primarily fibrous material comprises plastic, extruded polystyrene foam, metals, carbon filaments or any combination thereof.

17. The method of claim 1, wherein the primarily fibrous material comprises a combination of inorganic and organic materials

18. The method of claim 1, wherein the primarily lime based material comprises one or more of hydraulic lime or hydrated lime.

19. The method of claim 1, further comprising adding an additional binding agent during the step of mixing the primarily fibrous material with the primarily lime based material.

20. The method of claim 19, wherein the additional binding agent is a polymer based agent, polyester resins, cement, resins, silica sand, pozzolans, or any combination thereof.

21. The method of claim 1 adding a step either after step (a) or midway of step (c) of adding a web or compression strut between at least two of the members to hold them from movement relative to one another once the block is made.

22. A method for manufacturing an interlocking structural block comprising:
(a) positioning a plurality of members into a mold, such that one end of a member extends from one surface of the structural block with an opposite end of the member terminating partway within the structural block, wherein the mold is adapted for forming a plurality of apertures extending within the structural block from an opposing surface of the structural block, the apertures adapted for engaging with an extending end of an adjacent structural block;
(b) mixing hemp hurd, flax, hydraulic lime and hydrated lime for forming a block composition;
(c) applying the block composition into the mold;
(d) compressing the block composition;
(e) curing the block composition in the mold, such that the block composition is allowed to form around the plurality of members;
(f) injecting a quantity of carbon dioxide into the block composition; and
(g) setting the block composition in the mold for a predetermined period of time.

23. The method of claim 22 adding a step either after step (a) or midway of step (c) of adding a web or compression strut between at least two of the members to hold them from movement relative to one another once the block is made.

24. The manufactured block of claim 1.

25. The manufactured block of claim 21.

26. The manufactured block of claim 22.

27. The manufactured block of claim 23.
